(19) United States
(12) Patent Application Publication
(10) Pub. No.: US 2025/0052079 A1
(43) Pub. Date: Feb. 13, 2025

(54) Circular Framing Guide Laser Device

(71) Applicant: Aaron Delgadillo, Los Angeles, CA (US)

(72) Inventor: Aaron Delgadillo, Los Angeles, CA (US)

(21) Appl. No.: 18/514,385

(22) Filed: Nov. 20, 2023

Related U.S. Application Data
(60) Provisional application No. 63/518,181, filed on Aug. 8, 2023.

(51) Int. Cl. E04G 21/18

(52) U.S. Cl. CPC E04G 21/1875

(57) ABSTRACT

A circular framing guide laser device is provided. The device is comprised of a circular framing guide laser device having at least one laser lens that projects a continuous or non-continuous circular laser guide onto a surface such as, but not limited to, a ceiling. The laser lens is preferably automatically self-leveling and can be programmed to produce evenly spaced individual laser points to form a non-continuous circular laser guide. The diameter/radius of the circular laser guide is also adjustable.

### CROSS-REFERENCE TO RELATED APPLICATION

The present application claims priority to, and the benefit of, U.S. Provisional Application No. 63/518,181, which was filed on Aug. 8, 2023, and is incorporated herein by reference in its entirety.

### FIELD OF THE INVENTION

The present invention relates generally to the field of lasers. More specifically, the present invention relates to a circular framing guide laser device that can be used to project a circular laser guide onto a surface, such as a ceiling, to serve as a guide for carpentry framing. Accordingly, the present disclosure makes specific reference thereto. Nonetheless, it is to be appreciated that aspects of the present invention are also equally applicable to other like applications, devices, and methods of manufacture.

### BACKGROUND

Framing circular structures on a ceiling or any vertical surface can be an intricate and involved task. To do so, one typically needs to use a plurality of individual dot lasers. Each of these lasers must be adjusted by hand, which can be a tedious and inefficient process. This manual adjustment can require multiple attempts to ensure that the circle has a perfect radius. Not only does this consume a lot of time, but it also means that the task becomes more cumbersome than it should be. Such an approach can result in prolonged project timelines, which is not ideal, especially when seeking efficiency and precision.

Therefore, there exists a long-felt need in the art for a device that can be used to frame circular structures on a ceiling or other surface. There also exists a long-felt need in the art for a device that can be used to frame circular structures on a ceiling or other surface by projecting a laser guide onto the ceiling or surface. More specifically, there exists a long-felt need in the art for a circular framing guide laser device that projects a circular pattern on the ceiling or other surface. Further, there exists a long-felt need in the art for a circular framing guide laser device that projects a circular pattern on the ceiling or other surface using only a single device. In addition, there exists a long-felt need in the art for a circular framing guide laser device that projects a circular pattern on the ceiling or other surface without the need for manual adjustment.

The subject matter disclosed and claimed herein, in one embodiment thereof, comprises a circular framing guide laser device. The device is comprised of a circular framing guide laser device. The device is comprised of at least one laser lens that projects a continuous or non-continuous circular laser guide onto a surface such as, but not limited to, a ceiling. The laser lens is preferably automatically self-leveling and can be programmed to produce evenly spaced individual laser points to form a non-continuous circular laser guide. The diameter/radius of the circular laser guide is also adjustable via the device.

In this manner, the circular framing guide laser device of the present invention accomplishes all the foregoing objectives and provides a device that can be used to frame circular structures on a ceiling or other surface by projecting a laser guide onto the ceiling or surface. More specifically, the device does so while only using a single device. In addition, the device need not be manually adjusted.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a circular framing guide laser device. The device is comprised of a body with at least one laser lens. The laser lens produces a circular laser line onto a ceiling or other surface to provide a circular framing guide. The laser lens is preferably a self-leveling laser lens that automatically levels without input required from the user.

At least one laser beam from the lens exits the body via a first opening on the top surface of the body. This then allows the lens to project a laser image onto a ceiling above the device. The lens preferably produces at least one circle image made from individual beams (i.e., dashed) from multiple lasers that make up the laser lens or a continuous circular image. The laser lens may also produce a crosshair of any style in the middle of the circle to indicate the circle's center.

The radius and/or diameter of the circle may be adjusted via at least one button and seen on at least one display screen of the body. In an embodiment wherein the circle is non-continuous, at least one processor may compute and evenly space individual beams from the laser lens to form the circle. The button may also be used to activate/deactivate the laser lens, as well as change the style of laser guideline emitted by the lens. In one embodiment, the body may removably attach to at least one tripod with at least one leg.

The present invention is also comprised of a method of using the device. First, a device is provided comprised of a body comprised of at least one laser lens. Then, a user selects a radius distance and activates the laser lens such that a circular laser guide is projected onto a ceiling above the device or other surface. A user can also select whether the circular laser guide is a continuous line, dashed, and does/does not include a crosshair.

The present invention is also comprised of a second method of using the device. First, a device is provided comprised of a body comprised of at least one laser lens and a tripod comprised of at least one leg. Then, the body is attached to the tripod. Then, a user selects a radius distance and activates the laser lens such that a circular laser guide is projected onto a ceiling above the device or other surface. A user can also select whether the circular laser guide is a continuous line, dashed, and does/does not include a crosshair. Furthermore, a user can measure a distance between a ground surface and a ceiling using laser beams projected from the laser lens.

Accordingly, the circular framing guide laser device of the present invention is particularly advantageous as it provides a device that can be used to frame circular structures on a ceiling or other surface by projecting a laser guide onto the ceiling or surface. More specifically, the device does so while only using a single device. In addition, the device need not be manually adjusted. In this manner, the circular framing guide laser device overcomes the limitations of existing methods of using a laser to provide a circular framing template that are known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a circular framing guide laser device of the present invention projecting a crosshair and a circle onto a ceiling in accordance with the disclosed architecture;

FIG. 2 illustrates a perspective view of one potential embodiment of a circular framing guide laser device of the present invention projecting two laser beams in accordance with the disclosed architecture;

FIG. 3 illustrates a perspective view of one potential embodiment of a circular framing guide laser device of the present invention in accordance with the disclosed architecture;

FIG. 4 illustrates a flowchart of a method of using one potential embodiment of a circular framing guide laser device of the present invention in accordance with the disclosed architecture; and

FIG. 5 illustrates a flowchart of a method of using one potential embodiment of a circular framing guide laser device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to frame circular structures on a ceiling or other surface. There also exists a long-felt need in the art for a device that can be used to frame circular structures on a ceiling or other surface by projecting a laser guide onto the ceiling or surface. More specifically, there exists a long-felt need in the art for a circular framing guide laser device that projects a circular pattern on the ceiling or other surface. Further, there exists a long-felt need in the art for a circular framing guide laser device that projects a circular pattern on the ceiling or other surface using only a single device. In addition, there exists a long-felt need in the art for a circular framing guide laser device that projects a circular pattern on the ceiling or other surface without the need for manual adjustment.

The present invention, in one exemplary embodiment, is comprised of a circular framing guide laser device. The device is comprised of a body with at least one laser lens that produces a circular laser line onto a ceiling or other surface to provide a circular framing guide. The laser lens is preferably a self-leveling laser lens that automatically levels without input required from the user.

At least one laser beam from the lens exits the body via a first opening on the top surface of the body to allow the lens to project a laser image onto a ceiling above the device. The lens preferably produces at least one circle image made from individual beams (i.e., dashed) from multiple lasers that make up the laser lens or a continuous circular image. The laser lens may also produce a crosshair of any style in the middle of the circle to indicate the circle's center.

The radius and/or diameter of the circle may be adjusted via at least one button and seen on at least one display screen of the body. In an embodiment wherein the circle is non-continuous, at least one processor may compute and evenly space individual beams from the laser lens to form the circle. The button may also be used to activate/deactivate the laser lens, as well as change the style of laser guideline emitted by the lens. In one embodiment, the body may removably attach to at least one tripod with at least one leg.

The present invention is also comprised of a method of using the device. First, a device is provided comprised of a body comprised of at least one laser lens. Then, a user selects a radius distance and activates the laser lens such that a circular laser guide is projected onto a ceiling above the device or other surface. A user can also select whether the circular laser guide is a continuous line, dashed, and does/does not include a crosshair.

The present invention is also comprised of a second method of using the device. First, a device is provided comprised of a body comprised of at least one laser lens and a tripod comprised of at least one leg. Then, the body is attached to the tripod. Then, a user selects a radius distance and activates the laser lens such that a circular laser guide is projected onto a ceiling above the device or other surface. A user can also select whether the circular laser guide is a continuous line, dashed, and does/does not include a crosshair. Furthermore, a user can measure a distance between a ground surface and a ceiling using laser beams projected from the laser lens.

Accordingly, the circular framing guide laser device of the present invention is particularly advantageous as it provides a device that can be used to frame circular structures on a ceiling or other surface by projecting a laser guide onto the ceiling or surface. More specifically, the device does so while only using a single device. In addition, the device need not be manually adjusted. In this manner, the circular framing guide laser device overcomes the limitations of existing methods of using a laser to provide a circular framing template that are known in the art.

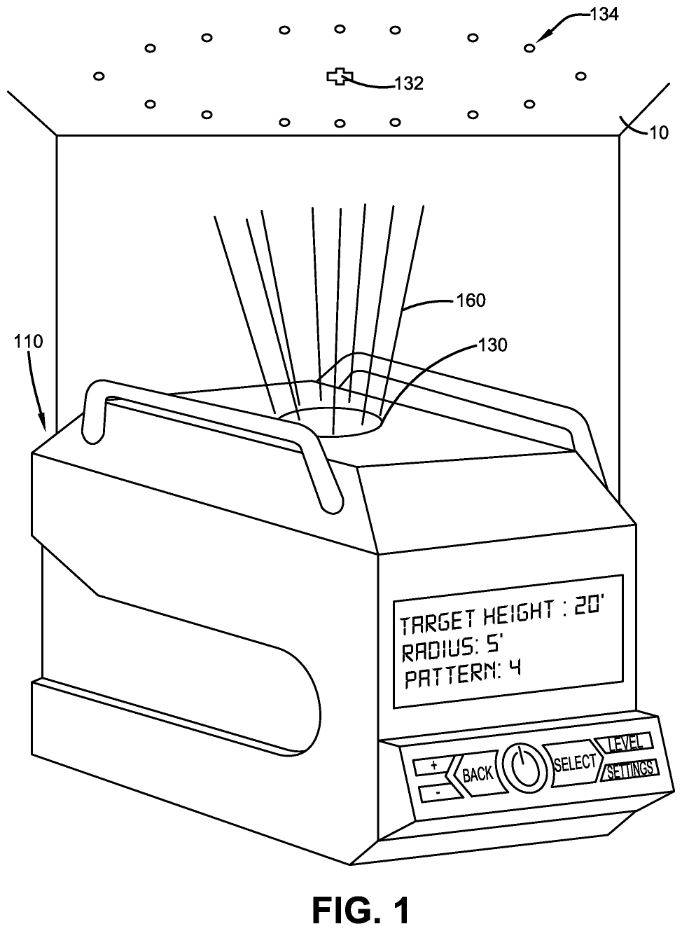

Referring initially to the drawings, FIG. 1 illustrates a perspective view of one potential embodiment of a circular framing guide laser device 100 of the present invention projecting a crosshair 132 and a circle 134 onto a ceiling in accordance with the disclosed architecture. The device 100 is comprised of a body 110 with at least one laser lens 130 that produces a circular laser line onto a ceiling 10 or other surface. As a result, the device 100 provides a circular framing guide wherein the diameter and position of the circle can be easily adjusted.

The device 100 is comprised of a body 110 that may be any shape and size. The body 110 may be made from a metal and/or plastic material. In one embodiment, the body 110 is protected by a rubber cover 120 that protects the body 110 against drops and impacts.

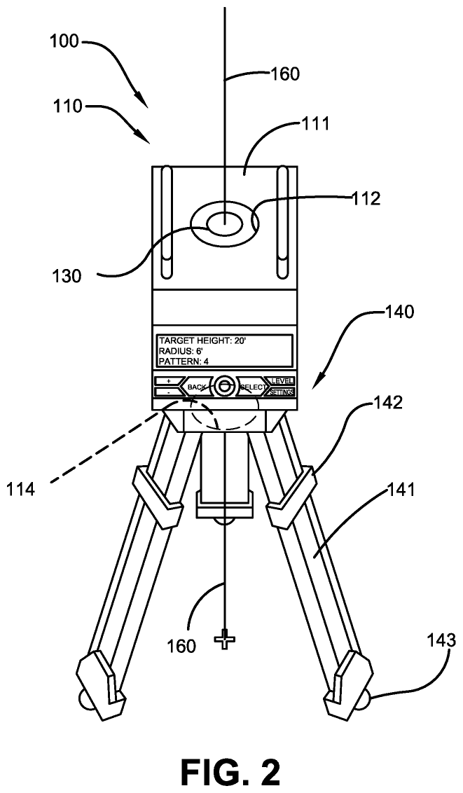

In one embodiment, the body 110 may removably attach to at least one tripod 140, as seen in FIG. 2. The tripod 140 has at least one leg 141. In one embodiment, the leg 141 is of a fixed length. In another embodiment, the leg 141 is telescopic, wherein the leg 141 can then be locked at a desired length via at least one locking member 142. The member 142 may be any telescoping locking member such as a rotating lock, a clasp, etc. Each leg 141 may also be comprised of at least one foot 143. In one embodiment, the foot 143 is repositionable and/or rotatable to allow the body 110 to be leveled.

The body 110 is comprised of at least one laser lens 130. The laser lens 130 is preferably a self-leveling laser lens that automatically levels without input required from the user. The laser lens 130 may be protected from drops or impacts by at least one guard rail 125 that may be positioned around the laser lens 130. The laser 130 may be any type and color known in the art. At least one laser beam 160 from the lens 130 exits the body 110 via a first opening 112 on top surface 111 of the body 110. This then allows the lens 130 to project a laser image onto a ceiling 10 above the device 100, as seen in FIG. 1. The lens 130 preferably produces at least one circle 134 image. However, the shape of the image may vary in different embodiments and may also include square, rectangular, etc. In one embodiment, the circle 134 is made from a continuous laser line. In another embodiment, the circle 134 may be made from individual beams 160 (i.e., dashed) from multiple lasers that make up the laser lens 130. The laser lens 130 may also produce a cross hair 132 of any style in the middle of the circle 134 to indicate the circle's 134 center.

The radius and/or diameter of the circle 134 may be adjusted via at least one button 122 and seen on at least one display screen 121 (of any screen type in the art such as, but not limited to, an LED screen or a touchscreen) of the body 110. In an embodiment wherein the circle 134 is non-continuous, at least one processor 150 may compute and evenly space individual beams from the laser lens 130 to form the circle 134. The button 122 may also be used to activate/deactivate the laser lens 130, as well as change the style of laser guideline emitted by the lens 130.

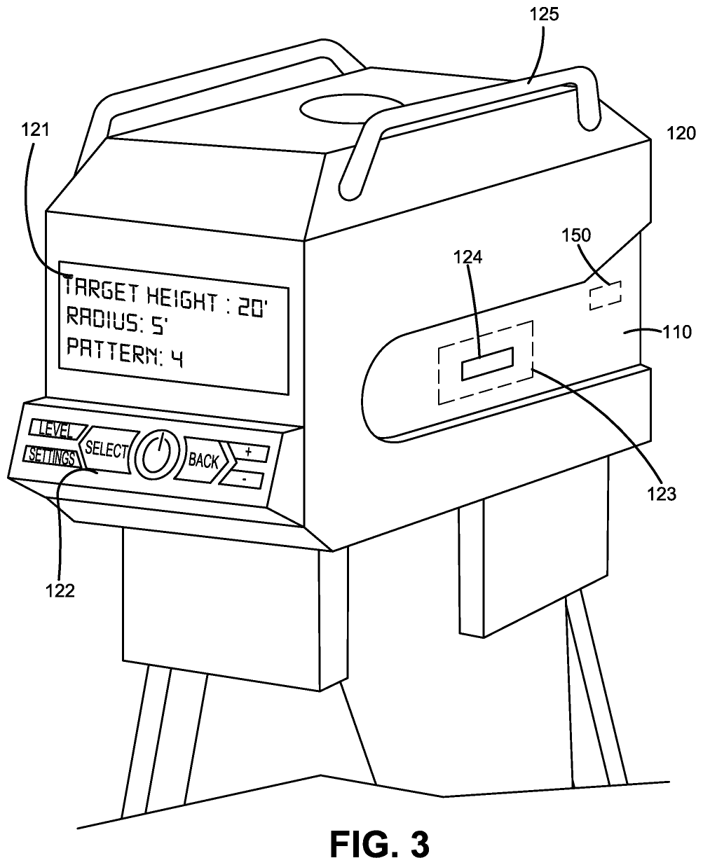

A user can also input the height of the ceiling 10. Alternatively, the laser 130 may measure the height of the ceiling 10 automatically via at least one laser beam 160 that exits the laser lens 130 the first opening 112, which contacts the ceiling 10 and reflects back to the device 100, and at least one laser beam 160 that exits the laser lens 130 through a second opening 114 of the body 110, wherein said laser beam then contacts a floor surface that the device 100 is suspended above and reflects back to the device 100, as seen in FIG. 3. In this manner, the readings from both beams in opposite directions from the laser lens 130 measures the distance between the ground surface and ceiling 10.

The lens 130 is powered by at least one battery 123. The battery 123 may be a removable battery that may be rechargeable or disposable. In another embodiment, the battery 123 is not removable and is comprised of at least one charging port 124, such as, but not limited to, a USB port, as seen in FIG. 3.

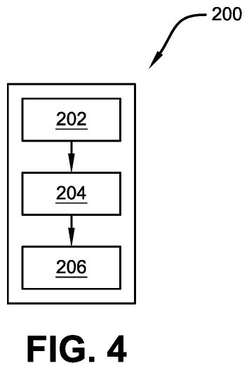

The present invention is also comprised of a method of using 200 the device 100, as seen in FIG. 4. First, a device 100 is provided comprised of a body 110 comprised of at least one laser lens 130 [Step 202]. Then, a user selects a radius distance and activates the laser lens 130 such that a circular laser guide is projected onto a ceiling 10 above the device 100 or other surface [Step 204]. A user can also select whether the circular laser guide is a continuous line, dashed, and does/does not include a crosshair [Step 206].

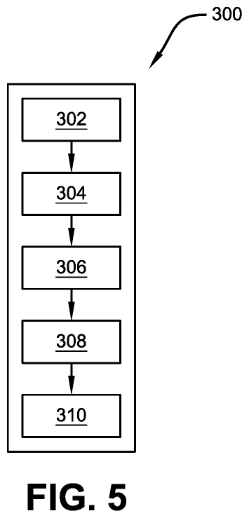

The present invention is also comprised of a second method of using 300 the device 100, as seen in FIG. 5. First, a device 100 is provided comprised of a body 110 comprised of at least one laser lens 130 and a tripod 140 comprised of at least one leg 141 [Step 302]. Then, the body 110 is attached to the tripod 140 [Step 304]. Then, a user selects a radius distance and activates the laser lens 130, such that a circular laser guide is projected onto a ceiling 10 above the device 100 or other surface [Step 306]. A user can also select whether the circular laser guide is a continuous line, dashed, and does/does not include a crosshair [Step 308]. Furthermore, a user can measure a distance between a ground surface and a ceiling 10 using laser beams 160 projected from the laser lens [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “circular framing guide laser device” and “device” are interchangeable and refer to the circular framing guide laser device 100 of the present invention.

Notwithstanding the foregoing, the circular framing guide laser device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the circular framing guide laser device 100 as shown in the FIGS. are for illustrative purposes only, and that many other sizes and shapes of the circular framing guide laser device 100 are well within the scope of the present disclosure. Although the dimensions of the circular framing guide laser device 100 are important design parameters for user convenience, the circular framing guide laser device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A circular framing guide laser device comprising:
a body comprised of a first opening;
a laser lens that projects a circular laser guide;
a battery; and
a display screen.

2. The circular framing guide laser device of claim 1, wherein the laser lens is comprised of a self-leveling laser lens.

3. The circular framing guide laser device of claim 1, wherein the circular laser guide is projected as a continuous laser line.

4. The circular framing guide laser device of claim 1, wherein the circular laser guide is projected as a non-continuous laser line.

5. The circular framing guide laser device of claim 1, wherein the laser lens projects a crosshair.

6. The circular framing guide laser device of claim 1, wherein the radius or the diameter of the circular laser guide is adjustable.

7. The circular framing guide laser device of claim 1, wherein the body is comprised of a protective cover.

8. The circular framing guide laser device of claim 1, wherein the body is comprised of a guard rail.

9. The circular framing guide laser device of claim 1 further comprised of a button.

10. The circular framing guide laser device of claim 1, wherein the display screen is comprised of a touch screen.

11. A circular framing guide laser device comprising:
a body comprised of a first opening;
a laser lens positioned on the body that projects a circular laser guide;
a battery;
a display screen positioned on the body; and
a tripod comprised of a leg, wherein the body removably attaches to the tripod.

12. The circular framing guide laser device of claim 11, wherein the tripod is comprised of a telescopic leg.

13. The circular framing guide laser device of claim 12, wherein the telescopic leg can be locked at a specific length via a locking member.

14. The circular framing guide laser device of claim 11, wherein the leg is comprised of a foot.

15. The circular framing guide laser device of claim 11, wherein the body is comprised of a second opening.

16. The circular framing guide laser device of claim 11, wherein the laser lens projects the circular laser guide via a laser beam.

17. The circular framing guide laser device of claim 11, wherein the laser lens can measure a distance between a ground surface and a ceiling.

18. The circular framing guide laser device of claim 11, wherein the laser lens is comprised of a self-leveling laser lens.

19. A method of using a circular framing guide laser device, the method comprising the following steps:
providing a circular framing guide laser device comprised of a body comprised of a laser lens; and
selecting a radius distance and activating the laser lens such that a circular laser guide is projected from the laser lens onto a surface.

20. The method of using a circular framing guide laser device of claim 19, wherein the surface is comprised of a ceiling.
